(19) United States
(12) Patent Application Publication
(10) Pub. No.: US 2011/0016253 A1
(43) Pub. Date: Jan. 20, 2011

(54) Auto-function USB port

(76) Inventors: Musa Ibrahim Kakish, Anaheim, CA (US); Johnny Hsiang-Yu Chen, Anahem, CA (US); Gary Kung, laguna Niguel, CA (US)

Correspondence Address: LAMBERT & ASSOCIATES, 92 STATE STREET, BOSTON, MA, 02109-2004, US

(21) Appl. No.: 12/584,787

(22) Filed: Sep. 11, 2009

Related U.S. Application Data
(60) Provisional application No. 61/226,245, filed on Jul. 16, 2009.

(51) Int. Cl. G06F 13/20

(52) U.S. Cl. 710/313

(57) ABSTRACT

An auto-function port located within a host computing machine or an external peripheral device, wherein the auto-function port is identified by the host computing machine through a unique product and vendor identification associated with an internal USB hub controller, thereby allowing for execution of an automated function by the host computing machine upon connection of a USB device with the auto-function port depending on the software configuration of the host computing machine and the type of USB device.

### CROSS REFERENCE TO RELATED APPLICATION

This application takes priority from and claims the benefit of Provisional Application Ser. No. 61/226,245 filed on Jul. 16, 2009 the contents of which are hereby incorporated by reference.

### BACKGROUND OF THE INVENTION

1. Field of the Invention

The present invention relates to Universal Serial Bus (“USB”) devices, and more particularly to USB ports, wherein at least one port is configured to execute a programmable function upon interaction with a USB device.

2. Description of the Related Art

Presently, a growing need and use of electronic USB devices exists, and as a result, consumers tend to look for simple, fast, and cost-effective means to execute an automated function upon connection of a USB device to a host computing machine. One such example of an automated function which may occur upon connection of an external USB storage device is a data archive or a back up process. Such automated function requires minimal user interaction.

### SUMMARY OF THE INVENTION

The primary object of the instant invention allows for the configuration of at least one downstream USB port in a hub controller in order to perform an automated function upon connection with a USB device.

Another object of the instant invention is to provide at least one downstream USB port that includes an identification tag or label in order to allow a user to identify the port as an auto-function port, wherein a host computing machine initiates an automated function upon connection of a USB device with the auto-function port.

Another object of the instant invention is to provide an auto-function port that allows for minimal user interaction in order to initiate a specific operation upon connection with a USB device to the auto-function port.

Another object of the instant invention is to provide an auto-function port that may be identified by a software service on the host computing machine in order to initiate an automated function upon connection with a USB device.

Another object of the instant invention is to provide an auto-function port that may be implemented on a host computing machine or an external peripheral device.

The instant invention provides for at least one auto-function port contained within a host computing machine or external peripheral device, wherein the host computing machine is able to identify an automated function associated with the auto-function port, upon connection with a USB device in the auto-function port, that allows only minimal user interaction to execute a specific function. Therefore, the instant invention provides a novel, cost-effective and simple means for a user to execute an automated function upon connection of a USB device with the auto-function port.

There has thus been outlined, rather broadly, the more important features of the auto-function port in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other to embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

To lend an understanding of the invention, a specific embodiment thereof will now be described by way of example and with reference to the accompanying drawings, in which:

FIG. 1 illustrates a block diagram of a host computing machine having an internal USB Hub controller, wherein the controller contains a unique vendor and product identification and includes a plurality of USB down stream ports;

FIG. 2 illustrates a block diagram of an alternate embodiment of the instant invention, wherein a separate controller in data communication with the hub controller interprets USB port status and configuration;

FIG. 3 illustrates a block diagram of an alternate embodiment of the instant invention, wherein an external mass storage device is connected to a specific USB port for execution of a specific function;

FIG. 4 illustrates a flow chart for operation of the instant invention following connection with a USB device;

FIG. 5 illustrates a diagrammatic perspective view of one embodiment of the instant invention, wherein an external storage device is connected to an auto-function USB port;

FIG. 6 illustrates a diagrammatic perspective view of one embodiment of the instant invention, wherein a monitor having a USB controller includes an auto-function USB port for connection with a USB device;

FIG. 7 illustrates a diagrammatic perspective view of one embodiment of the instant invention, wherein an all-in-one computing machine includes a plurality of USB downstream ports configured as an auto-function USB port;

FIG. 8 illustrates a diagrammatic perspective view of one embodiment of the instant invention, wherein a desktop computing machine includes an auto-function USB port for connection with a USB device; and

FIG. 9 illustrates a diagrammatic perspective view of one embodiment of the instant invention, wherein a Keyboard Video Mouse USB based switching product includes an auto-function USB port for connection with an external storage device.

### DETAILED DESCRIPTION OF THE PREFERRED EMBODIMENT

In operation, both computing machines, including but not limited to desktop computers and all-in-one computers, along with external peripheral devices, including but not limited to external storage devices and printers, possess an internal USB hub configuration, wherein the hub controller includes unique vendor identification (“VID”) and product identification (“PID”) numbers. It is known in the art that when a USB device is connected, the device identifies itself by its VID/PID combination, thereby allowing for the identification of drivers (if any) to be used for the USB device.

In a preferred embodiment, the hub configuration includes a plurality of USB ports, wherein the instant invention provides for one USB port to be to be in data communication with a host computing machine to launch and/or initiate a specific function upon initial connection of a USB device. Therefore, this USB port will possess a specific auto-function that will commence upon connection with a USB device (hereinafter referred to as “Auto-Function Port” and/or “AFP”). The AFP allows for minimal user interaction to undertake the specific function associated with the AFP upon connection of a USB device.

In use, the instant invention provides for the ability to configure a specific USB downstream port in a hub controller to perform an automated function upon connection with a USB device.

In the preferred method of operation, the connection of a USB device to an Auto-Function Port will result in the performance of an automated function on the host computing machine, wherein the function is preferably determined by the software service. In one embodiment, the software will provide a specific function to the AFP, wherein the AFP will contain a separate function from the other downstream USB ports present in the hub controller, so that when a USB device makes connection, the automated function will initiate. Conversely, if a USB device is plugged into a port other than the auto-function port, then the automated function associated with the AFP will not commence; the USB enumeration will follow the conventional process determined by the running operating system defaults on the host computing machine.

Additionally, a software service running on the host computing machine will be able to identify the AFP and detect the USB device plugged into the AFP to commence the automated function associated with the auto-function port. As such, a to user will only be required to plug and unplug the USB device from the auto-function port. Furthermore, once the software service running on the operating system of the host computing machine identifies and isolates the auto-function port, the software will monitor the connection of a valid USB device to the AFP, and subsequently launch the function associated with that port. Therefore, the host computing machine possesses the ability to isolate, identify and validate the connection of a USB device, when the connection is made to the previously identified auto-function port; upon validation the automated function associated with the port will commence, including, but not limited performing a backup or upload archive file processing. In one embodiment, the function associated with the AFP allows for the upload multimedia contents of a USB device that are attached to a YouTube® or Flickr® service as specified by the above validation and identification.

With respect to the automated function associated with the AFP upon connection to a USB device, this function may comprise a pre-configured function by a user for the AFP. One example of a pre-configured function which may occur upon initial connection of a USB device with the AFP is an auto back-up or media playing, wherein a message prompt will alert the user of the automated function upon initial connection. In alternate embodiments, a user possesses the ability to change the function of the AFP by accessing the configuration of the AFP and either resetting or changing the function upon connection with a USB device.

The implementation of the instant invention is shown in the below figures and accompanying description from both a hardware and software perspective. It should be readily apparent to those of ordinary skill in the art, that the instant invention is not limited to the embodiments, computing machines and/or peripheral devices disclosed.

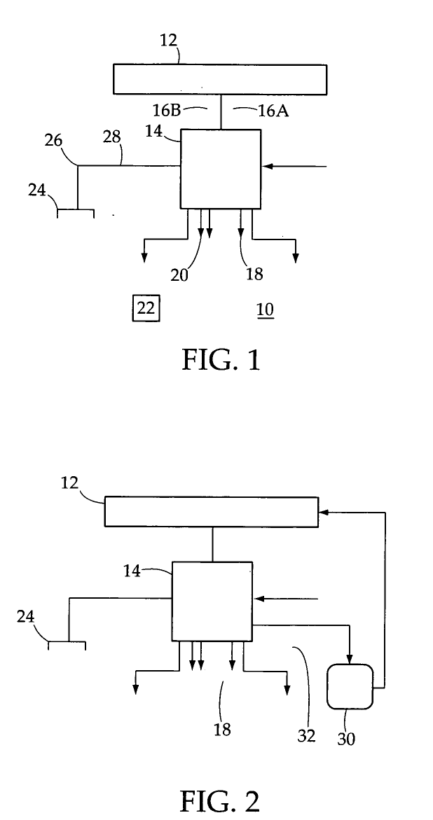

FIG. 1 illustrates a block diagram of the instant invention 10, wherein a host computing machine 12 is in data communication with a USB hub controller 14 via an upstream USB port 16A or a Peripheral Component Interconnect Express (“PCIe”) or Peripheral Component Interconnect (“PCI”) 16B. The hub controller 14 further includes a plurality of downstream USB ports 18, wherein at least one downstream port 18 is an auto-function port 20 that allows for connection with a USB device 22. The connection of the USB device 22 with the AFP 20 allows for the host computing machine 12 to initiate an automated function associated with the auto-function port 20.

In a preferred embodiment, the AFP 20 includes a separate identification tag or label that allows a user to differentiate the AFP 20 with the automated function from other downstream USB ports 18 present on the hub controller 14. In one embodiment, a light emitting diode (“LED”) or array 24 may be incorporated with the hub controller 14, wherein the LED 24 is in data communication with the hub controller 14 through a General Purpose Input/Output (“GPIO”) interface 26 via a plurality of Small Computer System Interface (“SCSI”) commands 28. In yet another embodiment, the SCSI commands 28 may be vendor or standard USB commands. Therefore, in operation of the preferred embodiment, the LED array 24 is controlled via the SCSI commands 28 from the host computing machine 12 via the hub controller 14. In yet another embodiment, a separate USB hub controller may be incorporated with the hub USB arrangement to monitor and display the progress of the automated function after a USB device makes connection with the AFP 20.

As known in the art, computing machines 12 may possess multiple USB host controllers 14 within the same system. Therefore in the preferred embodiment, the hub controller 14 which includes the AFP 20 will possess a unique VID/PID in order to allow the software service present on the host computing machine 12 to properly identify the hub controller 14. In one embodiment, the VID/PID is internally programmed into the to Read-Only Memory (“ROM”) of the hub controller 14; in another embodiment the VID/PID is provided via an external flash drive; in yet another embodiment the VID/PID is provided via an external Electrically Erasable Programmable Read-Only Memory (“EEPROM”).

FIG. 2 illustrates an alternate embodiment of the instant invention 10, wherein the configuration and status of the downstream USB ports 18 and the AFP 20 is in data communication with the host computing machine 12 via a separate controller 30. The controller 30 is in data communication with the hub controller 14 via a Serial Peripheral Interface Bus (“SPI”) 32 including, but not limited to a SPI 12C. Therefore, in operation of this embodiment, the configuration of the USB ports 18 and 20 is relayed to the software service of the host computing machine 12 through the controller 30 via the hub controller 14.

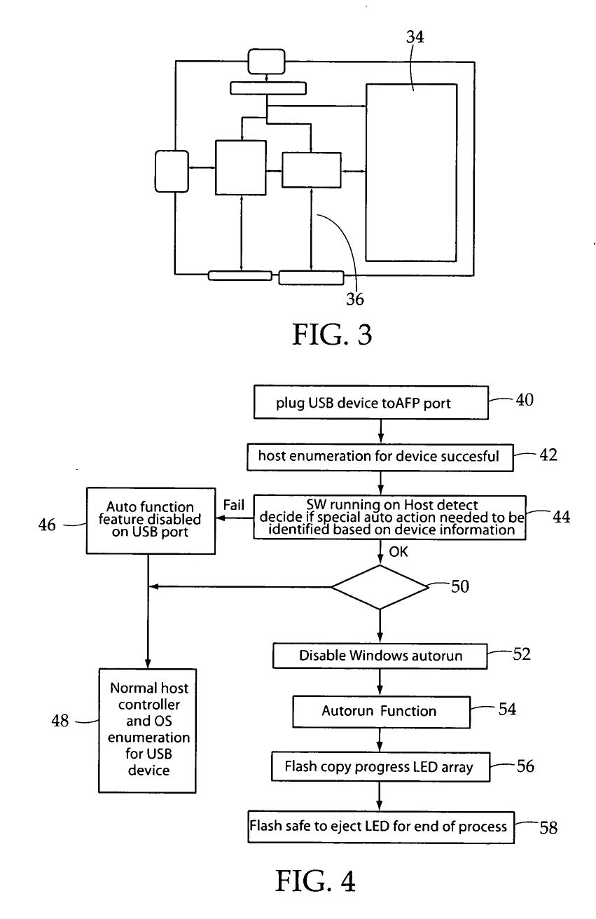

FIG. 3 illustrates yet another alternate embodiment of the instant invention 10, wherein the auto-function port 20 interfaces with an external mass storage USB device 34. In this embodiment, the mass storage device 34 is in data communication with the hub controller 14 via a Serial ATA 36. In this embodiment, the hub controller 14 includes a plurality of Type-A and Type-B USB ports 38.

FIG. 4 illustrates a flow chart for the software implementation of the instant invention, wherein at step 40 a USB device 22 makes connection with the auto-function port 20. At step 42, the host enumeration for the USB device is successful. At step 44, the software service present on the host computing machine 12 detects the USB device 22 plugged into the auto-function port 20. At step 46, if the automated function associated with the AFP 20 is disabled, then the USB device 22 will undergo normal enumeration through the hub controller 14 and operating system of the host computing machine at step 48. At step 50, if the automated function of the AFP 20 is not disabled, however the host computing device 12 fails to initiate the function configured with the AFP 20, then normal enumeration for the USB device 22 occurs through step 48. At step 52, if the software service running on the host computing machine 12 properly detects that a USB device 22 is plugged into the AFP 20 and determines that the automated function associated with the AFP 20 should be initiated, then the Microsoft® Windows autorun is disabled. At step 54, once the windows autorun is disabled, the automated function associated with the AFP 20 in connection with the USB device 22 is initiated by the host computing machine 12. At step 56, once the automated function of the AFP 20 is initiated, the LED array 24 monitors the progress of the automated function. At step 58, the LED array 24 indicates that the automated function process is complete and the USB device 22 may be removed from the auto-function port 20.

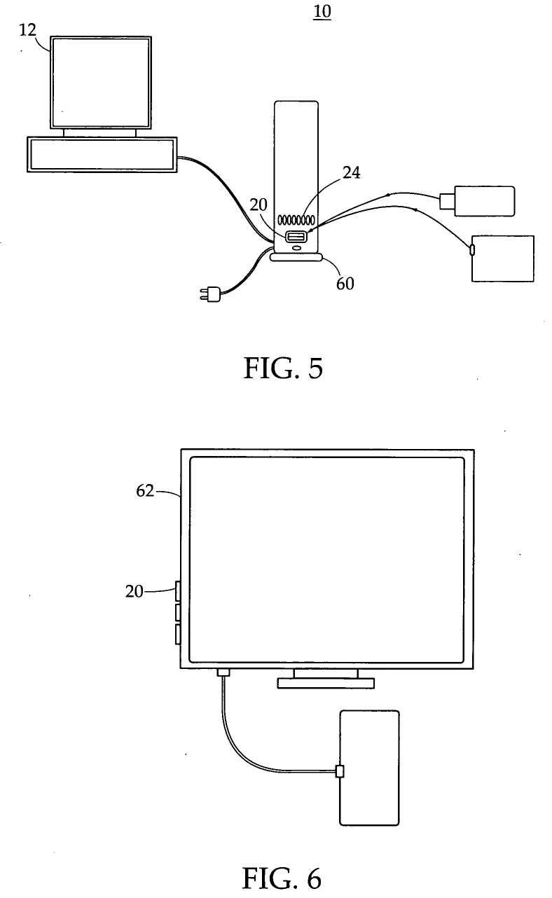

FIG. 5 illustrates one embodiment for implementation of the instant invention 10 with an external storage device. In this embodiment, the host computing machine 12 is in data communication with the auto-function port 20 via a USB connection. Furthermore, as described above, the instant invention includes an LED array 24 to monitor and display the progress of the automated function associated when the USB device, in this embodiment, an external storage device makes connection with the AFP 20. Furthermore, the AFP 20 may include an LED “bi-color” 60 to indicate when the USB device may be safely removed from the auto-function port 20.

FIG. 6 illustrates yet another embodiment for implementation of the instant invention 10 with a monitor 62, wherein the monitor 62 includes an integrated hub controller 14 having an auto-function port 20. In this embodiment, the monitor 62 is in data communication with the host computing machine 12 via a Type-B USB controller. Additionally, the monitor 62 includes a plurality of downstream USB ports 18, wherein one of the downstream ports 18 may be configured to an auto-function port 20; as described above, an LED array 24 may also be incorporated into this embodiment to monitor the progress of the automated function.

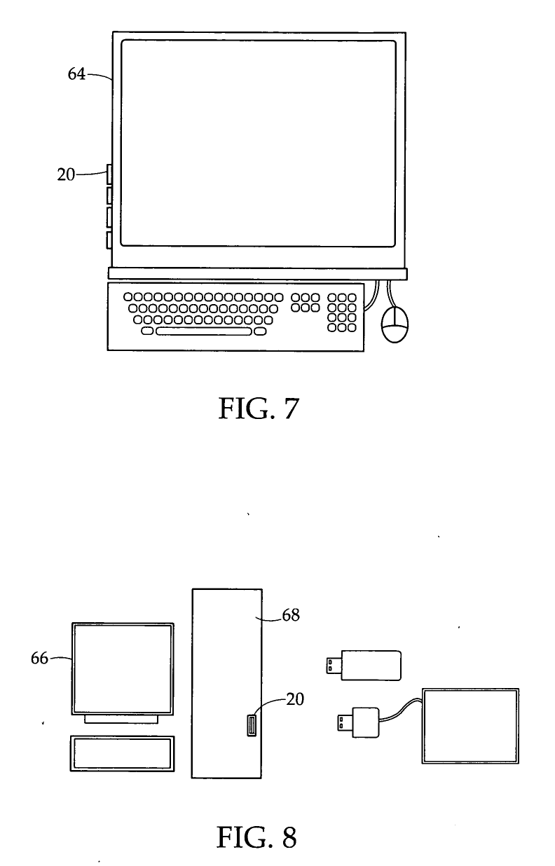

FIG. 7 illustrates yet another alternate embodiment for implementation of the instant invention 10 with an all-in-one computing machine 64, wherein the all-in-one computing machine 64 includes a plurality of downstream USB ports 18. In this embodiment, one or more of the downstream USB ports 18 may be configured by a user into an auto-function port 20 and include an identification tag or label to alert the user of the auto-function port 20. In this embodiment, a graphical indicator may be present on the monitor in close proximity to the AFP 20, to indicate to a user that a USB device 22 is plugged into the AFP 20, along with displaying the progress of the automated function, such as an auto backup of a USB mass storage device.

FIG. 8 illustrates yet another embodiment for implementation of the instant invention 10 with a desktop computing machine 66, wherein the desktop computing machine 66 includes an auto-function port 20 located within the central processing unit (“CPU”) 68.

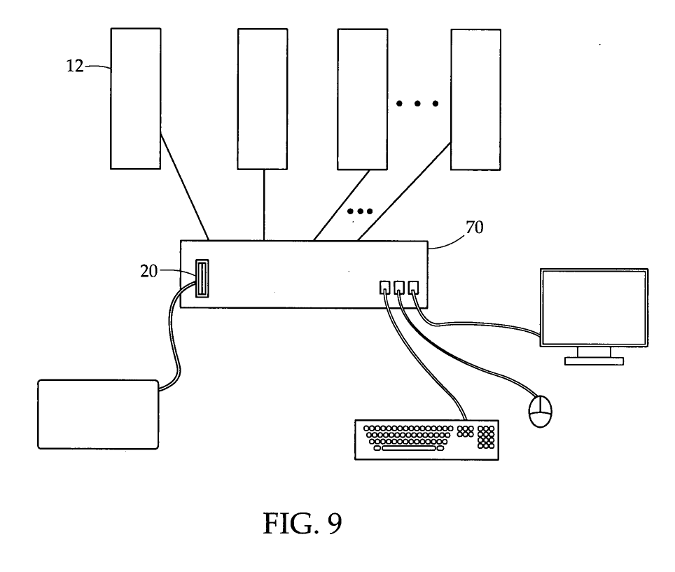

FIG. 9 illustrates yet another embodiment for implementation of the instant invention 10 with a Keyboard Video Mouse (“KVM”) USB based switching product 70, wherein the KVM 70 includes an auto-function port 20. In this embodiment, the addition of the AFP 20 to the KVM 70 console panel enables a user to connect a mass storage device to the AFP 20, and in turn be able to connect to a plurality of host computing machines 12. Furthermore, each time a user switches between different host computing machines 12, the AFP 20 will subsequently switch to the corresponding host computing machine 12. Once the AFP 20 makes the switch to a new host computing machine 12, an automated function will be initiated, including but not limited to creating an incremental to back up; in this embodiment an LED array 24 or similar device may be incorporated to provide a user with the progress of the automated function. Lastly, in this embodiment, a user will be required to install the software service on any host computing machine 12 connected to the KVM 70; all host computing machines 12 are in data communication with the KVM 70 via a USB connection.

In addition to the alternate embodiments described above, there are several additional usage scenarios contemplated by the instant invention, including but not limited to:
1) Plugging a mass storage device to the AFP 20, wherein the automated function initiates creating an auto backup archiving or indexing operation on the host computing machine 12 to transfer data from the mass storage device to the main storage on the host computing device.
2) Plugging a mass storage device with multimedia files content to the AFP 20, wherein the automated function initiates playing and/or indexing the multimedia and storing it to the main storage on the host computing device; the type of USB device may be a picture or video camera, or other similarly functioning device.
3) Plugging an USB composite device such as a smart phone to the AFP, wherein the automated function initiates an auto synchronization process between the contents of the USB composite device and the host computing machine 12 to synchronize the contents and contacts of the stored files.
4) The implementation of the AFP 20 on an external primary mass storage USB device, wherein if a separate USB device 22 makes connection with the AFP 20, then the automated function initiates an auto back up and/or archive process between both USB devices. In this embodiment, the only interaction required by a user will be simply plugging the secondary USB device into the primary USB to device. Furthermore, an LED or LED array 24 may be implemented on the primary mass storage USB device 22 to display to a user the progress and completion of the automated function, and when the USB device may be safely removed from the auto-function port 20.

In yet additional alternate embodiments, a user may select what actions need to occur upon plugging a USB device 22 into the AFP 20 during an initial set-up. Also, in alternate embodiments, the instant invention may include a plurality of USB ports which may be configured by the user to each become an auto-function port 20 upon detecting a USB device plugged to any one of the auto-function ports 20. Also, the instant invention may function as a means of data transfer upload and translation per AFP 20 in a USB host computing machine 12, where multiple USB connections exist. Lastly, host computing machine 12 having hub controllers 14 fall into this category as well, wherein an auto-function port 20 on a hub controller 14 may be identified by through the VID/PID of the hub controller 14, along with identifying the AFP 20 per its specific parameters of the software service on the host computing machine 12.

In yet another alternate embodiment, a user may select which downstream USB port(s) 18 located within the hub controller 14 of a host computing machine 12 or other similar device, may be configured to perform a specific function based on the needs and personality of a user. In this embodiment, a graphical user interface (GUI) running on the operating system of the host computing machine 12 will provide a user with a map, identifying the locations of different downstream ports on the host computing machine 12. In one embodiment, the GUI may store and display the configuration of the port(s) to a user to allow for easy identification of each function. Thus, a user will be able to identify those ports which possess the most desirable accessibility and the type of function to be associated with each of the ports depending on the configuration needs of the user. Moreover, a user can configure multiple downstream ports to initiate different functions during a one-time configuration as previously described. One possible example of such configuration may be a port for connection of a USB mass storage device, a port for uploading pictures to an online storage or posting website, and a port for uploading videos to a multimedia broadcast website including, but not limited to YouTube®.

The instant invention is not intended to be restricted to the details of the above described embodiments. It is understood that the embodiments described herein are merely illustrative of the instant invention. Variations in the applications and implementation of the auto-function port may be contemplated by one of ordinary skill in the art without limiting the intended scope of the instant invention disclosed herein and as defined by the following claims.

We claim:

1. A system utilizing an automated function USB port comprising:
a host computing machine;
a universal serial bus hub controller, wherein the hub controller is in data communication with the host computing machine;
a plurality of downstream USB ports, wherein the downstream USB ports are located within the USB hub controller; and
a plurality of auto-function USB ports, wherein the auto-function USB ports are located within the USB hub controller.

2. The system of claim 1, wherein the data communication between the hub controller and the host computing machine is selected from the group consisting of an upstream USB port, a peripheral component interconnect and a peripheral component interconnect express.

3. The system of claim 1, wherein the hub controller possesses a vendor identification and product identification number.

4. The system of claim 3, wherein the vendor identification and product identification number is provided through a device selected from the group consisting of an external flash drive, an external electrically erasable programmable read-only memory and a hub controller read-only memory.

5. The system of claim 1, wherein a software service present on the host computing machine initiates an automated function associated with the auto-function port upon connection with a USB device.

6. The system of claim 5, wherein a light-emitting diode array is in data communication with the hub controller to provide a visual progress of the automated function upon connection of a USB device with the auto-function port.

7. The system of claim 6, wherein the light-emitting diode array is in data communication with the hub controller through a general purpose input/output interface via a plurality of small computer system interface commands.

8. The system of claim 1, wherein the system further includes a separate controller is in data communication with the host computing machine and the hub controller.

9. The system of claim 8, wherein the controller is in data communication with the to hub controller via serial peripheral interface bus.

10. The system of claim 8, wherein the controller identifies the status and configuration of the USB ports located within the hub controller and relays the status and configuration of the USB ports to the host computing machine.

11. The system of claim 1, wherein the auto-function port interfaces with an external mass storage USB device.

12. The system of claim 11, wherein the external mass storage USB device is in data communication with the hub controller via a Serial ATA.

13. The system of claim 1, wherein the auto-function port interfaces with a monitor having an integrated hub controller and is in data communication with a host computing machine via a Type-B USB connection.

14. The system of claim 1, wherein the auto-function port interfaces with an all-in-one computing machine having a plurality of downstream USB ports.

15. The system of claim 1, wherein the auto-function port interfaces with a desktop computing machine.

16. The system of claim 1, wherein the auto-function port interfaces with a Keyboard Video Mouse USB based switching product.

17. The system of claim 16, wherein the auto-function port interfaces with an external mass storage device to allow for data communication between the mass storage device and a plurality of host computing machines.

18. The system of claim 17, wherein a user switches between different host computing machines, the auto-function port will subsequently switch to the corresponding host computing machine.

19. A method of initiating an automated function on a host computing machine using the system of claim 1, comprising the steps of:
receiving a USB device in an auto-function port;
running a host enumeration for the USB device by the host computing device;
detecting the USB device by the host computing machine via a software service present on the host computing machine;
deciding whether an automated function associated with the connection of the USB device to the auto-function port should be initiated by the host computing machine;
deciding to initiate the automated function associated with the connection of the USB device to the auto-function port;
disabling the Windows autorun;
initiating the automated function by the host computing machine;
displaying the progress of the automated function through an light-emitting diode array located within the hub controller; and
removing the USB device from the auto-function port upon completion of the automated function.

20. The method of claim 19, wherein if the host computing machine does not determine to initiate the automated function upon connection of a USB device with the auto-function port, then standard USB enumeration is initiated.
